(19) United States
(12) Patent Application Publication
(10) Pub. No.: US 2008/0109782 A1
(43) Pub. Date: May 8, 2008

(54) METHOD AND SYSTEM FOR PIN ASSIGNMENT

(75) Inventors: Maxim Adelman, New York, NY (US); Stephen Fischer, Edison, NJ (US)

Correspondence Address: MCDONNELL BOEHNEN HULBERT & BERGHOFF, LLP, 300 SOUTH WACKER DRIVE, CHICAGO, IL, 60606, US

(73) Assignee: UTStarcom, Inc., Alameda, CA (US)

(21) Appl. No.: 11/550,723

(22) Filed: Oct. 18, 2006

(51) Int. Cl. G06F 17/50

(52) U.S. Cl. 716/16

(57) ABSTRACT

Methods and systems for assigning package pins of an electronic device to logical pins of a device design to be implemented on the electronic device are disclosed. An example method includes receiving a technology description file for the electronic device, where the technology description file includes a catalog of information for the electronic device. The method further includes receiving a design description file for the device design, where the design description file includes a catalog of information for the device design. A database is created from the technology description file and the design description file, where the database is for use in assigning the package pins of the electronic device to the logical pins of the device design. The method still further includes programmatically assigning the package pins of the electronic device to the logical pins of the device design using the database.

### BACKGROUND

I. Field

This disclosure relates to methods and systems for performing signal pin assignments in high pin-count devices, such as field programmable gate arrays and/or application specific integrated circuits.

II. Description of Related Art

Field programmable gate arrays (FPGAs) and application specific integrated circuits (ASICs) are two types of devices that are often used during product development of electronic systems. FPGAs and/or ASICs are typically used during the process of product development to “debug” a system design in order to determine a “final” design that may then implemented in a final product that is sold to customers. The final system design may or may not include FPGAs and/or ASICs. For instance, circuits implemented in the FPGAs and/or ASICs during system development may be implemented in custom designed integrated circuits in the “final” product.

Both FPGAs and ASICs allow product designers to quickly make changes to a product (e.g., circuit) design during the development phase of a system or product (e.g., such as a microprocessor). For instance, FPGAs and ASICs contain standard circuit elements (such as logic gates, input/output structures, etc.) that may be connected to one another to implement a desired device, or circuit design. By changing the connections in the FPGA or ASIC device, iterations of the design can be tested relatively quickly as compared to reproducing the entire design (e.g., an entire new microprocessor component).

In the case of FPGAs, the various circuit elements implemented in an FPGA electronic device are selectively connected to one another using electrically programmable interconnects. Such interconnects may be implemented using, for example, flash memory cells. Because interconnects in an FPGA are electrically programmable (and erasable), changes to a system or product design can be made very quickly and often without even removing the FPGA from a printed circuit board in which it is included, where the system or product design is implemented using the printed circuit board. This allows for very quick evaluation of design “fixes” during product debug. FPGAs, however, are generally slower and less complex than ASIC devices. Also, FPGAs typically consume more power than comparable ASIC devices.

ASIC devices, on the other hand, are generally faster (have better circuit performance), allow for implementing more complex designs and consume less power than comparable FPGA devices. However, in contrast to FPGAs, the various circuit elements implemented in ASIC devices are selectively interconnected using masking layers, such as contact layers and/or metal layers of a semiconductor process used to manufacture the ASIC device. Therefore, implementing design changes in an ASIC device takes longer than in an FPGA, as one or more masking layers for the ASIC device must be produced to implement each iteration of a particular design. The decision whether to use an FPGA or an ASIC, accordingly, depends on the particular situation.

FPGAs and ASICs, notwithstanding their relative complexity, are generally, what may be termed, high pin-count devices. For instance, FPGAs and ASICs may be assembled in electronic device packages (e.g., ball-grid arrays) that have hundreds of package pins, which include power supply pins, signal pins, special function pins, among any number of other types of package pins. A device design (e.g., a circuit design) may be implemented in an FPGA or ASIC by assigning “logical pins” of the device design to package pins of the FPGA or ASIC. “Logical pins” of the device design may be defined as signals used in the device design that must be externally accessible (e.g., input and output signals of the device design) once the device design is implemented in the FPGA or ASIC.

Assigning the logical pins of a device design to the package pins of an FPGA or ASIC device may be a very complex process. For instance, the process of assigning the logical pins to the package pins must take into account a number of factors, such as the compatibility of the properties of the logical pins with the properties of the package pins, timing considerations for the input and output signals of the device design, and board layout considerations for implementing the FPGA or ASIC in a system board, among any number of other considerations that must be taken into account when assigning the logical pins to the package pins. Current approaches for making such logical pin to package pin assignments have certain drawbacks.

One approach that is currently used for assigning logical pins to device design pins is to perform a manual assignment of the logical pins to the package pins. In such an approach, a design engineer manually selects the package pin that is to be assigned to each logical pin of the device design. For designs of even moderate complexity, such a process is highly labor intensive and requires a great amount of skill on the part of the engineer performing the pin assignments. As the complexity of the device design being implemented increases, the ability to achieve an acceptable set of logical pin to package pin assignment becomes non-practical using such a manual approach.

A second approach that is used for assigning logical pins to package pins is the use of graphical tools that assist in the assignment process. Such tools provide a visual representation of the FPGA or ASIC device. The visual representation of the FPGA or ASIC illustrates the limitations and/or properties of the package pins (such as through color coding or shading). Such tools may also provide an engineer making logical pin to package pin assignments with an indication when the properties of a logical pin do not match the properties of a package pin or a signal pin bank in which the package pin is included. As is known, signal pins in FPGA devices may be divided into “signal pin banks”, where the signal pin banks share certain properties, such as power supply voltage, input reference voltage and differential reference voltage, as some examples. While an improvement over a completely manual assignment approach, the use of such graphical tools is still a highly labor intensive process and requires a significant amount of skill on the part of the design engineer performing the assignment, especially for more complex designs.

A third approach for performing logical pin to package pin assignments is the use of automated place and route software. In the first two approaches discussed above, logical pin to package pin assignments may be performed before completion of the device design to be implemented in an FPGA or ASIC, such approaches may reduce system development time, as system board layout and the process of designing the device being implemented in the FPGA may be done in parallel. However, in the third approach, system board design cannot be done in parallel as the logical pin to package pin assignments are not completed until after the device design is complete. Additionally, place and route software applications do not take into account timing considerations and location of interfaces of device design to other components on the system board (e.g., board layout considerations).

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are given by way of example and meant to be illustrative, not limiting in scope. In various embodiments, one or more of the above-described problems have been reduced or eliminated, while other embodiments are directed to other improvements.

Methods and systems for assigning package pins of an electronic device to logical pins of a device design to be implemented on the electronic device are disclosed. One example method includes receiving a technology description file for the electronic device, where the technology description file includes a catalog of information for the electronic device. The catalog of information for the electronic device may include a description of each package pin of the electronic device including, for each package pin: (i) a signal bank assignment, (ii) a pin type, (ii) a physical location and an (iv) electronic device pin name. The catalog of information for the electronic device may further include a description of each type of input/output structure available on the electronic device. The description for each type of input/output structure may include one or more of: (i) input and output voltages, (ii) input reference voltages and (iii) differential reference voltages, which may be used to determine signal pin bank properties.

The example method further includes receiving a design description file for the device design, where the design description file includes a catalog of information for the device design, such as information regarding the input and output properties of the design. The catalog of information for the device design may include, for each logical pin of the device design: (i) a device design pin name, (ii) an input/output type, an input/output direction; and (iii) assignment heuristics, where the assignment heuristics include information for assigning the logical pins to the package pins, such as direct pin assignments and signal bank limitations, for example.

The example method also includes creating a database from the technology description file and the design description file. The database may be created by combining the information in the catalog of information for the electronic device and the catalog of information for the device design. The database is then used to programmatically assign the package pins of the electronic device to the logical pins of the device design.

In particular methods, the package pins of an electronic device are assigned to logical pins of a device design in multiple passes. In such an approach, logical pins of the device design that have assignment heuristics that include a direct pin assignment may be assigned in a first pass (e.g., a first pass through the database). Logical pins of the device design with assignment heuristics that include a bank limitation may be assigned in a second pass. A bank limitation may be defined as a limitation on the signal pin banks of the electronic device to which a particular logical pin may be assigned. Such a bank limitation may be defined for timing considerations, board layout considerations, or for any number of other reasons. After completion of the first two passes for assigning package pins to the logical pins, logical pins of the device design with assignment heuristics that include an unrestricted assignment designator may be assigned. Logical pins with unrestricted assignment designators may be assigned to any available package pin with compatible signal pin bank and package pin properties.

Once assignment of package pins to logical pins is complete, the example method may further include creating one or more output files including the pin assignments. For instance, a file that may be used by place and route software may be generated. Additionally, a spreadsheet file that graphically illustrates the package pin to logical pin assignments may be generated as an alternative to, or in addition to the place and route output file. Depending on the particular embodiment, other output files may also be generated, such as a list of restrictions for system board layout for a printed circuit board in which the electronic device will be implemented.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flowchart illustrating a method for assigning package pins of an electronic device to logical pins of a device design to be implemented on the electronic device;

FIG. 2 is a schematic drawing illustrating an example package pinout for an example electronic device;

FIG. 3 is a table illustrating an example pin assignment output file produced by the method of FIG. 1;

FIG. 4 is a schematic diagram illustrating example logical pin to package pin assignments for the package pinout of FIG. 2;

FIG. 5 is a table illustrating a first portion of a technology description file that may be used in the method of FIG. 1;

FIG. 6 is a table illustrating a second portion of a technology description file that may be used in the method of FIG. 1;

FIG. 7 is a table illustrating a device design description file that may be used in the method of FIG. 1;

FIG. 8 is a flowchart illustrating a method for programmatically assigning package pins of an electronic device to logical pins of a device design to be implemented on the electronic device;

FIG. 9 is a flowchart illustrating a method for assigning direct assignment design pins in the method of FIG. 8;

FIG. 10 is a flowchart illustrating a method for assigning bank-limited design pins in the method of FIG. 8; and

FIG. 11 is a flowchart illustrating a method for assigning unrestricted design pins in the method of FIG. 8.

### DETAILED DESCRIPTION

Methods for assigning package pins of an electronic device, such as a field programmable gate array (FPGA) and/or an application specific integrated circuit (ASIC) are disclosed. Such methods may be implemented using a computer workstation that includes a machine readable medium storing instructions that, when executed, implement such methods. For the sake of clarity, the methods described herein will be described generally with reference to FPGA devices. However, it will be appreciated that the methods described herein may also be used for assigning package pins for ASIC devices or any number of other types of devices.

### Method for Assigning Package Pins to Logical Pins

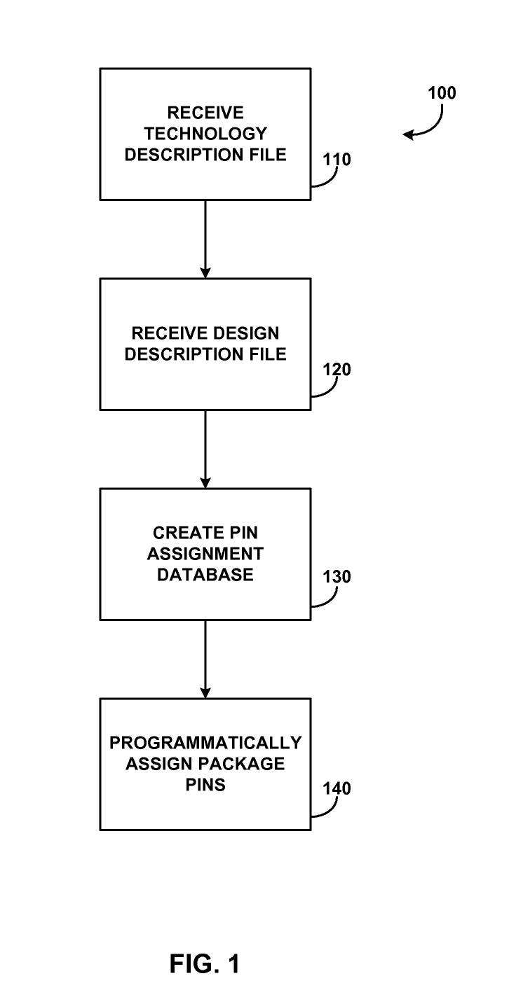

FIG. 1 is a flowchart that illustrates a method 100 for assigning package pins of an electronic device (e.g., for purposes of this disclosure, an FPGA) to logical pins of a device design to be implemented on the FPGA. As is known, a given FPGA device may include a semiconductor chip that has various circuit elements formed on the chip. The circuit elements that are formed on the FPGA chip may include standard logic gates, flip-flops, various types of input/output structures and configuration circuitry, among any number of other types of circuits or circuit elements (collectively “circuit elements”). The circuit elements of the FPGA are interconnected using electrically programmable interconnects (e.g., flash memory cells) to implement a device design (such as a particular circuit) on the FPGA device. The same device design may be implemented using an ASIC device where circuit elements are interconnected using masking layers to define the connections between circuit elements.

Part of the process of implementing a device design using an FPGA (or an ASIC) is the process of assigning package pins of a particular FPGA device to logical pins of the device design, where the logical pins of the device design correspond with the input and output signals of the device design. As part of the process of assigning package pins to logical pins, a number of considerations may be taken into account. For instance, timing considerations for the signals associated with the logical pins may be considered, as well as the physical location of the package pin assignments for the logical pins on the FPGA device (e.g., for circuit board layout considerations). When assigning package pins to logical pins, the compatibility of the properties of the package pins with the properties of the logical pins is also considered. For instance, a package pin with a 3.3V power supply voltage should not be assigned to a logical pin that is defined as a 2.5V input/output structure. In such a case, the package pin properties would be incompatible with the logical pin properties.

The method 100 may be used for assigning package pins of an FPGA device to logical pins of a device design, while taking into account considerations such as those noted above. The method 100 includes, at block 110, receiving a technology description file, such as at a computer workstation. In this situation, the technology description file of the method 100 is a data file that is readable by a workstation implementing the method 100.

The technology description file received at block 110 includes a catalog of information about a particular FPGA device and electronic device package combination (the “FPGA device” or “FPGA”). For instance, the technology description file includes descriptive information regarding the particular FPGA device, such as (i) a listing of the package pins of the FPGA device, (ii) information regarding the groupings of pins in particular signal pin banks, and (iii) information regarding the types of input/output structures available on the particular FPGA device, among any number of other details about the FPGA device that could be used in the process of assigning package pins of the FPGA to logical pins of a device design. The technology description file is specific to a particular FPGA device/electronic device package combination. Accordingly, once prepared, a given technology description file may be used for assigning package pins of a particular FPGA device included in a particular electronic device package (e.g., a 512 pin ball-grid array) to logical pins of any device design that is to be implemented on that particular combination.

The method 100 also includes receiving a design description file at block 120. The design description file of the method 100 may also be a data file that is readable by a workstation implementing the method 100. The design description file includes a catalog of information regarding a particular device design to be implemented on an electronic device, such as an FPGA (or ASIC). In the examples described herein, the design description file includes information only about the input and output structures of a given device design. For these examples, the design description file does not include a complete description of the given device being implemented. For instance, the design description file includes descriptions of the logical pins of the device design that are to be assigned to package pins of the FPGA device on which the design is to be implemented. The design description file may also include information regarding groupings of logical pins (e.g., buses) and properties of the logical pins (e.g., input/output type, reference voltages, etc.).

Additionally, the design description file may include assignment heuristics that are used in assigning package pins of an FPGA to logical pins of a device design. The assignment heuristics may define criteria for pin assignments such as (i) direct pin assignments, (ii) limitations on the signal pin banks of the FPGA to which given logical pins can be assigned. Alternatively, the assignment heuristics for certain logical pins may not include any limitations on assignment. In this situation, such logical pins may be assigned to any package pin where the signal pin bank properties (e.g., power supply voltage) and package pin properties (e.g., pin function) are compatible with the logical pin properties of those “unrestricted” pins.

The method 100 further includes, at block 130, creating a pin assignment database from the technology description file and the design description file. The pin assignment database may be created by simply combining the information in the technology description file with the information in the design description file. The database may take the form of a spreadsheet or, alternatively, could be implemented in a database application, such as a relational database application. Regardless of the particular form of the pin assignment database, the information in the pin assignment database is used for assigning package pins of the FPGA device described in the technology description file to logical pins of the device design described in the design description file.

The method 100 further includes, at block 140, programmatically assigning package pins of the FPGA device described in the technology description file to the logical pins of the device design described in the received design description file. The pin assignments may be accomplished using a computer workstation that includes a machine readable medium which stores instructions that, when executed, assign package pins of the FPGA to logical pins using the information included in the pin assignment database. The machine readable medium storing the instructions may be physically included in the computer workstation or, alternatively, may be accessed by the work station over a computing network.

### Example Package Pinout for Electronic Device

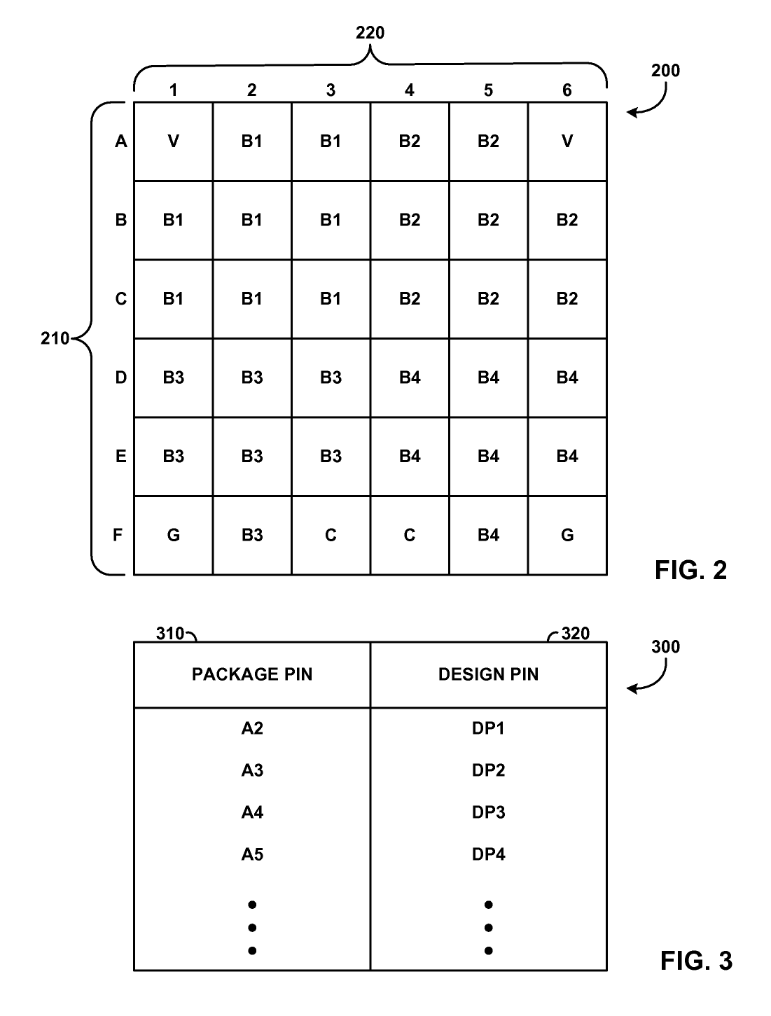

FIG. 2 is a drawing illustrating an example package pinout 200 for an electronic device on which a device design may be implemented. The package pinout 200 may be a package pinout for an FPGA or an ASIC. For purposes of this discussion, package pinout 200 will be generally referred to as an FPGA package pinout. Also, the package pinout 200 is a simplified pinout for purposes of brevity and clarity. It will be appreciated that pinouts for FPGAs associated with the methods described herein may be significantly more complex than the pinout 200 illustrated in FIG. 2. For instance, such FPGAs may include hundreds of package pins, which implement any number of different package pin functions, such as reference voltage pins and special function pins (e.g., scan chain pins), among other functions.

For the pinout 200, package pins are arranged in rows 210 and columns 220. The rows 210 for the pinout 200 are designated with the letters A-F and the columns 220 are designated with the numbers 1-6. Physical pin locations of the pinout 200 are referred to by their corresponding row and column intersection. For instance, the package pin the in upper left corner of the pinout 200 is referenced as pin A1. Likewise, the pin in the bottom right corner of the pinout 200 is referred to as pin F6.

As shown in FIG. 2, the pins of the pinout 200 also have additional designations in FIG. 2. For instance, pins A1 and A6 are designated ‘V’, which indicates that these pins are power supply pins (e.g., Vcc pins). The power supply pins may be considered to be in a power supply bank ‘V’ or alternatively may included in one of the signal pin banks indicated in FIG. 2, such as are described below. As is also shown in FIG. 2, pins F1 and F6 of the pinout 200 are designated ‘G’, which indicates that these pins are ground pins. In like fashion as the power supply pins, the ground pins may be considered to be in a ground bank ‘G’ or may be included in one or more of the signal pin banks.

Pins F3 and F4 of the pinout 200 are designated ‘C’, which indicates that these pins are configuration pins for an FPGA corresponding with the pinout 200. In FIG. 2, the pinout 200 also includes designations of four signal pin banks of the corresponding FPGA. For instance, package pins of the pinout 200 associated with a first signal pin bank are each designated ‘B1’ in FIG. 2. Likewise, package pins of the pinout 200 associated with second, third and fourth signal pin banks of the corresponding FPGA are each respectively designated ‘B2’, ‘B3’ and ‘B4’ in FIG. 2. This information is included in the technology description file for the FPGA associated with the package pinout 200 and that information is then included in the pin assignment database for use in assigning package pins from the pinout 200 to logical pins of a device design to be implemented in an FPGA corresponding with the pinout 200.

### Output Files

Methods for assigning package pins to logical pins as described herein may also include producing one or more output files that include the assignments made by such methods. FIG. 3 is a table illustrating a portion of an example output file 300 that may be generated by such methods. The output file 300 includes a listing of package pin designations in column 310 for the pinout 200 of FIG. 2 and a listing of corresponding logical pins (design pin) to which the package pins have been assigned in column 320. For instance, as shown in the output file 300, the package pin A2 is assigned to logical pin ‘DP1.’

The output file 300 may include a listing of each package pin of the pinout 200 and its corresponding logical pin assignment. Further, the output file 300 may include additional information, such as information for use in implementing a corresponding device design in the FPGA corresponding with the pinout 200. This additional information may include signal bank properties, such as supply and reference voltages, for example. Furthermore, the output file 300 may be in a format that is usable by a place and route application, such as in a data file that may be termed a “constraints file.” The output file 300 may then be used in conjunction with the design of a printed circuit board in which the associated FPGA device used to the implement the device design is to be used.

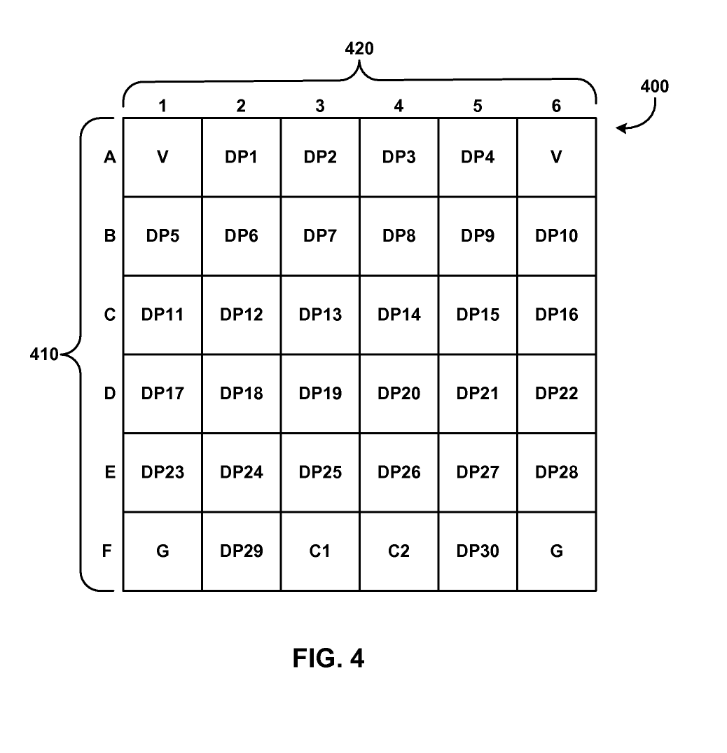

FIG. 4 is a drawing illustrating an alternative output file 400 that may be generated in place of, or in addition to the output file 300 of FIG. 3. The output file 400 may be in the form of a spreadsheet file that graphically illustrates the assignments of package pins of the pinout 220 shown in FIG. 2 to the logical pins (design pins) of a particular device design to be implemented in an FPGA corresponding with the pinout 200.

In the output file 400, in like fashion as in FIG. 2, package pins are arranged in rows 410 and columns 420. The package pins of the rows 410 and columns 420 in FIG. 4 correspond with the package pins of the rows 210 and columns 220 shown in FIG. 2. However, in FIG. 4, as compared to FIG. 2, the logical pin assigned to each of the package pins is indicated, rather than an indication of the signal pin bank associated with each package pin. For instance, package pin A2 is assigned to logical pin ‘DP1.’ It is noted that the output file 400 corresponds with the output file 300 shown in FIG. 3. As a further example of such pin assignment designations, the configuration pins F3 and F4 of the pinout 220 are shown as being assigned to logical pins ‘C1’ and ‘C2’ of the device design, as is shown in FIG. 4.

The output files described above with respect to FIGS. 3 and 4 are given by way of example. It will be appreciated that additional output files may be generated using the methods described herein. Also, the output files generated by such methods may eliminate certain information or may include additional information regarding package pin to logical pin assignments, as well as information for implementing a device design on an electronic device (e.g., an FPGA or ASIC), such as signal pin bank properties and/or package pin properties, among other types of information, such as logical pin properties.

### Technology Description File

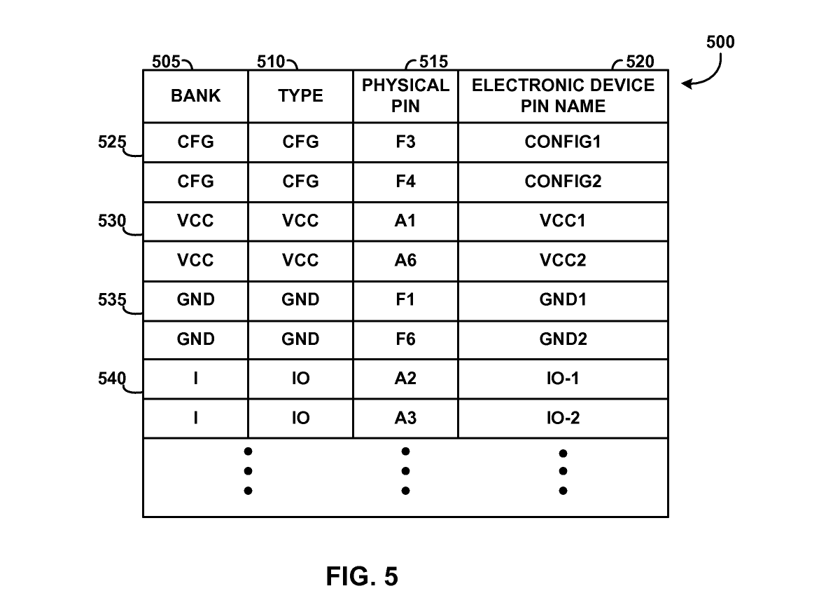

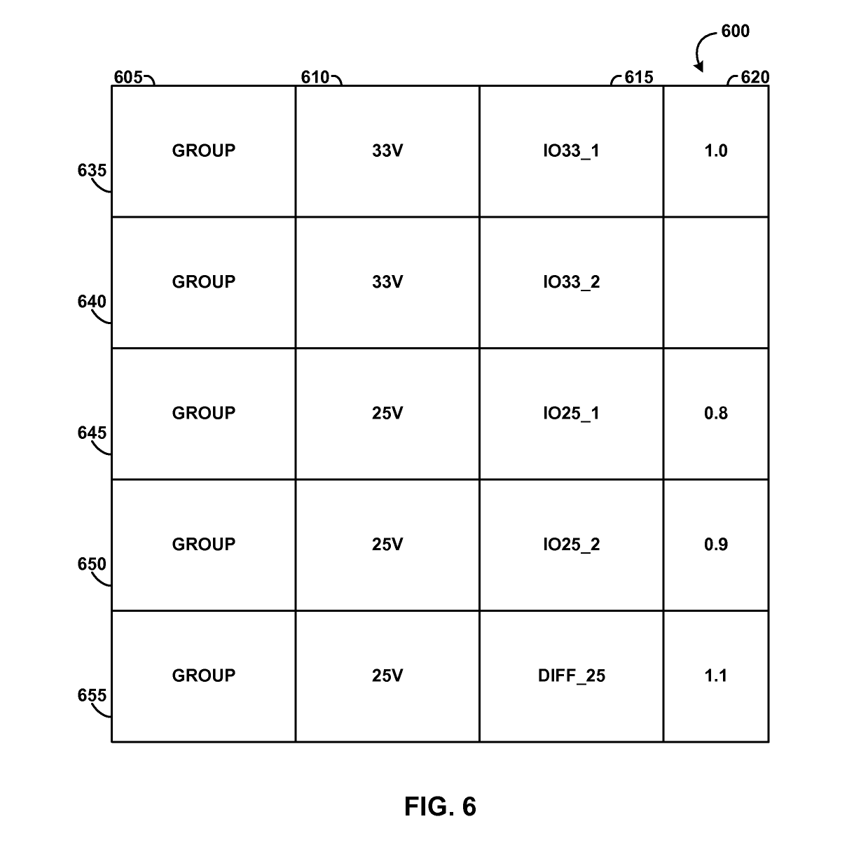

FIGS. 5 and 6 are tables 500, 600 that respectively illustrate two parts of an example technology description file that may be used in conjunction with the method of FIG. 1, or other methods described herein. The tables 500, 600 correspond with the pinout 200 shown in FIG. 2 and described above. Additionally, the tables 500, 600 correspond with the output files 300, 400 illustrated in FIGS. 3 and 4, which were also described above.

The table 500 in FIG. 5 illustrates a portion of a first part of a technology description file that corresponds with an FPGA device with a package pinout as illustrated in FIG. 2. In the table 500, each pin of the associated FPGA device is described in rows with characteristics of each pin being listed in corresponding columns of the table 500. The table 500 includes a column 505, which includes indications, for each package pin, of a corresponding bank (e.g., signal pin bank) associated with the respective package pin. The table 500 also includes (i) a column 510 that includes, for each package pin, a pin type, (ii) a column 515 that includes, for each package pin, an associated physical package pin grid location and (iii) a column 520 that includes, for each package pin, a package pin name for the particular FPGA device.

It will be appreciated that the table 500 does not list every package pin for the package pinout 200 illustrated in FIG. 2. The table 500 is given by way of example to illustrate information that may be included in a technology description file. Rows 525,530,535,540 in the table 500 include some example pin descriptions, as may be included in a technology description file used in conjunction with the methods described herein.

In row 525, package pin F3 of the package pinout 200 illustrated in FIG. 2 is described. The package pin F3 is indicated as being part of a configuration bank (CFG) in column 505 and of a configuration type (CFG) in column 510. Depending on the particular FPGA being used, a package pin that is designated as being of type CFG may indicate that that particular package pin has certain properties, such as a specific input/output structure or a dedicated function. The particular significance of each pin type designation included in column 510 depends, at least in part, on the particular embodiment. The physical pin location (F3) is listed in column 515 of row 525 and a package pin name “CONFIG_1” associated with the package pin F3 is provided in column 520.

One of the power supply package pins (A1) and one of the ground pins (F1) of the package pinout 200 illustrated in FIG. 200 are described, respectively, in rows 530,535 of the table 500. As shown in FIG. 5, the power supply pin A1 is included in a VCC pin bank (column 505), is of type VCC (column 510) and is assigned a package pin name of VCC1 (column 520). Similarly, the ground pin F1 is included in a GND pin bank (column 505), is of type GND (column 510) and is assigned a package pin name of GND1 (column 520).

In row 540, package pin A2 of the package pinout 200 illustrated in FIG. 2 is described. The package pin A2 is a signal pin and is indicated as being part of a signal pin bank 1 in column 505 (as is also indicated in the pinout 200 of FIG. 2) and is indicated as an input/output pin (IO) type in column 510. Depending on the particular FPGA device being used, a package pin that is designated as being of type IO may operate using any one of a number of input/output structures that are implemented by the particular FPGA. The type of input output structure that is used may be defined in a design description file associated with a device design to be implemented using the FPGA. When implementing the device design in the FPGA, the desired input/output structure is coupled with the package pin A2 using an electrically programmable interconnect, as has been previously described. The physical pin location (A2) of the signal pin associated with row 540 is listed in column 515 and a package pin name “IO_1” associated with the package pin A2 is provided in column 520.

The table 500 includes example information and package pin descriptions that may be included in a technology description file. It will be appreciated that a technology description file used for pin assignments in the methods described herein would list each package pin of an FPGA for which pin assignments are being made, along with a corresponding description of each pin. Further, any number of other pin types and/or functions may be included in such a technology description file. For instance, reference voltage package pins may be defined to provide input reference voltages, differential references voltages, or any other appropriate reference voltages that may be used for a particular FPGA device. Also, where appropriate, any number of additional types of configuration pins may be described in such a technology description file. For instance, JTAG pins may be implemented in an FPGA device and described in a corresponding technology description file. Still further, other types of signal pins may be described in a technology description file. For instance, such signal pins may include differential pairs, input only pins and output only pins, among any number of other possible signal pin types.

The table 600 in FIG. 6 illustrates a second portion of the example technology description file. The table 600 includes information regarding IO structures that are implemented (supported) by an FPGA device that corresponds with the technology description file of FIGS. 5 and 6. Those working in this area will appreciate that the table 600 may include additional information or may eliminate information. Also, the information in table 600 could be divided between multiple tables or sections of a technology description file. For instance, the IO structures could be described in one section, while the operating voltages are described in a separate section.

The IO structures discussed below with respect to FIG. 6 are illustrative. The IO structures implemented on a particular FPGA will depend, in part, on the particular applications for which the FPGA is intended to be used. For instance, the IO structures described in such an FPGA technology description file may include differential IO structures for use in implementing analog circuits. As another example, an FPGA intended for use in implementing microprocessor designs may include Peripheral Component Interconnect (PCI) IO structures that are described in a technology description file, such as in the table 600. Of course, it is possible to implement any number of other types of IO structures on a particular FPGA device.

The table 600 includes columns 605,610,615,620 and rows 635,640,645,650,655. Each row describes a specific IO structure with information for each IO structure being included in the columns of the table 600. For example, each row of column 605 in the table 600 includes a designator “GROUP”. The GROUP designator is used to group compatible IO structures together in the technology description file. For instance, as shown in column 610 of the table 600, the structures described in rows 635,640 are designated as being part of GROUP “33V”, which indicates that the IO structures described in rows 635,640 operate at a power supply voltage of 3.3V and are, therefore, compatible with respect to operating voltage (e.g., may be located in the same signal pin bank due to their same operating voltage).

In FIG. 6, column 615 designates the particular type of IO structure corresponding with each row of the table 600. For instance, for the GROUP 33V, row 635 of the table 600 corresponds with an IO structure “IO33_1” while row 640 of the table 600 corresponds with an IO structure “IO33_2.” The particular features and operation of each IO structure included in an FPGA device will depend on the particular embodiment.

Column 620 in FIG. 6 designates any references voltages (e.g., input reference voltages) for the IO structures listed in the table 600. For example, column 620 indicates that the IO structure IO33_1 of row 635 uses a reference voltage of 1.0 V. In comparison, column 620 indicates that the IO structure IO33_2 of row 640 does not use a reference voltage. In this situation, because IO33_2 does not use a reference voltage (e.g., input reference voltage), the IO structures IO33_1 and IO33_2 the reference voltage designations for IO33_1 and IO33_2 are also compatible. Therefore, package pins assigned to logical pins of a device design using these IO structures may be located in the same bank. As is known, IO structure operating voltages (bank voltage) and reference voltages (input reference voltages) for FPGA devices are typically defined on a signal pin bank level (e.g., using bank properties). For instance, all of the package pins in a given signal bank operate at the same power supply voltage and have access to a reference voltage that is common across the given signal pin bank.

The IO structures described in rows 645,650,655 are all part of a GROUP 25V (e.g., use a 2.5 V operating voltage), as is indicated in column 610 of these rows. The IO structures of GROUP 25V are designated IO25_1 in row 645, IO25_2 in row 650 and DIFF_25 in row 655. While these structures are compatible with respect to operating voltage, they may not be located in the same signal pin banks due to their reference voltages. For instance, the IO structure IO25_1 uses a reference voltage of 0.8 V, as is indicated in column 620 of row 645. In comparison, the IO structure IO25_2 uses a reference voltage of 0.9V, while the IO structure DIFF_25 uses a reference voltage of 1.1 V. Because each of the IO structures of the GROUP 25V uses a different reference voltage, package pins of a corresponding FPGA that are assigned to logical pins of a device design using these IO structures would be located in signal pin banks with bank properties that match both their operating voltage (2.5 V) and their respective reference voltages. Those working in this area will appreciate that additional IO structures may be described in such a technology description file that are compatible with one, or all of the IO structures of the GROUP 25V (e.g., a 2.5 V IO structure that does not use a reference voltage).

### Design Description File

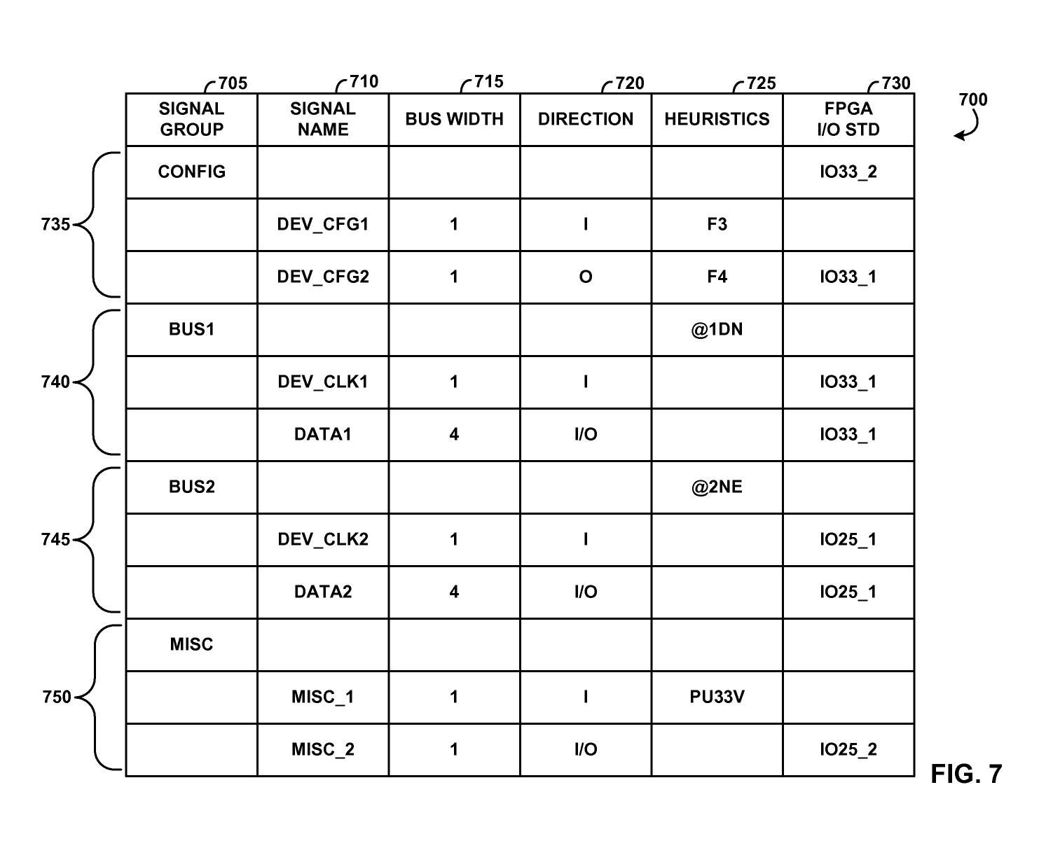

FIG. 7 is a table 700 that represents a design description file for a particular device design that is to be implemented on an FPGA device that corresponds with the pinout 200 of FIG. 2 and the technology description file of FIGS. 5 and 6. The table 700 may take the form of a spreadsheet file (e.g., an Excel spreadsheet), or any other appropriate format. The design description file is a catalog of information regarding the particular device design. The design description file of FIG. 7 is intended to be illustrative for purposes of this disclosure. FIG. 7 is described with further reference to FIGS. 2, 5 and 6. Those working in this area will appreciate that, depending on the particular device design, such a design description file may define hundreds (or thousands) of logical pins to be assigned to package pins of an FPGA device.

The design description file represented by the table 700 includes groups of signal pins. The signal groups are designated in column 705 of the table 700. Column 710 lists the logical pin signal names of the device design for each of the signal groups designated in column 705. In the table 700, listings of signal groups each begin with a designation of a group name in column 705. The signal pins of each signal group are then listed on subsequent lines of the table 700. Each designation in column 705 indicates the beginning of a new signal group. Of course, alternative approaches may be used separating signal groups in the table 700. For instance, blank lines could be used to separate signal groups in the table 700. Such an approach would allow for readily defining signal groups that include only a single logical pin or defining groups of related pins. For such groups, a signal group designation may, or may not be included in column 705.

Using methods for assigning package pins to logical pins as described herein, the logical pins of each signal group of the table 700 may be assigned to FPGA package pins in sequence in order to assure that related logical pins are assigned in close physical proximity to one another on the FPGA package (e.g., for timing considerations or physical location on the FPGA package).

In FIG. 7, the table 700 includes various information about the logical pins of the particular device design represented. For instance, signal bus widths are defined in column 715 of the table 700. A width of ‘1’ indicates that a single logical pin is associated with the corresponding signal name in column 710. A width of greater than ‘1’ in column 715 of the table 700 indicates that multiple pins (e.g., a bus) are associated with the corresponding signal name.

Respective signal directions of the logical pins of the device design of FIG. 7 are designated in column 720. These designations include ‘I’ for input only, ‘O’ for output only and I/O for input/output. Such information may be used during pin assignment. For instance, when assigning a logical pin designated as output only to a particular signal pin bank, input reference voltages may be ignored when determining compatibility of the logical pin with the bank properties of the particular signal pin bank. Input reference voltages can be ignored in this situation because an output only logical pin would not use an input reference voltage.

Column 725 of the table 700 includes assignment heuristics for the logical pins listed in the design description file of FIG. 7. Column 730 includes designations of the IO structures (as described in the technology description file, e.g., the table 600) to be used for the respective logical pins of the device design associated with the design description file of FIG. 7 when assigned to package pins of an FPGA device corresponding with the technology description file. Each of these designations is described further in the following discussion.

The table 700 includes four signal groups. The first signal group 735 is designated “CONFIG” in column 705. The CONFIG signal group 735 includes two logical pins “DEV_CFG1” and “DEV_CFG2”, as indicated respectively in column 710 on the two lines following the designation of the CONFIG signal group 735 in column 705. DEV_CFG1 and DEV_CFG2 are single logical pins (bus width of “1”) that are to be assigned to package pins of an FPGA. The width of “1” for these logical pins is indicated in column 715 of the table 700. Further, DEV_CFG1 is designated as an input only pin in column 720, while DEV_CFG2 is designated as an output only pin.

As noted above, column 725 of the table 700 includes assignment heuristics for the logical pins of a device design represented by the design description file of FIG. 7. The assignment heuristics for the logical pins DEV_CFG1 and DEV_CFG2 are what may be termed direct pin assignments. For instance, column 725 indicates that the logical pin DEV_CFG1 should be assigned to package pin “F3” of the pinout 200 illustrated in FIG. 2, while column 725 indicates that the logical pin DEV_CFG2 should be assigned to package pin “F4” of the pinout 200.

Both the assignment heuristics (in column 725) and the designations of the IO structures to use (in column 730) may be designated for a signal group as a whole (e.g., for the CONFIG signal group 735), or may be designated for each logical pin (or bus) individually. For instance, column 730 of the table 700 designates the IO structure IO33_2 should be used with assigning logical pins of the CONFIG signal group 735 to package pins of the FPGA. However, column 730 also designates the IO structure of DEV_CFG2 as IO33_1. In this situation, the designation for the individual logical pin (DEV_CFG2) would override the signal group designation for the CONFIG signal group 735. Also, individual logical pin assignment heuristics may override signal group assignment heuristics in a similar fashion.

Using the foregoing approach for the device design of FIG. 7, the logical pin DEV_CFG1 would be assigned to package pin F3 using IO33_2 as an IO structure and the logical pin DEV_CFG2 would be assigned to package pin F4 using IO33_1 as an IO structure. The bank properties for the CFG bank of the package pinout 200 after these pin assignments would be (i) an operating voltage of 3.3 V and (ii) a reference voltage of 1.0 V. These pin assignments would be compatible because IO33_1 and IO33_2 both belong to GROUP 33V and only IO33_1 uses a reference voltage.

The table 700 of FIG. 700 includes three other signal groups, a “BUS1” signal group 740, a “BUS2” signal group 745 and a “MISC” signal group 750. The BUS1 signal group 740 includes a logical pin “DEV_CLK1”, which is an input only pin and a logical bus “DATA1” with a width of “4” (four logical pins). The logical pins of the bus DATA1 are input/output pins. Both DEV_CLK1 and DATA1 use IO33_1 (from the table 600) as an input or IO structure. Alternatively, the designation of IO33_1 for the BUS1 signal group 740 could be made for the entire signal group rather than for the individual logical pins, as shown in FIG. 7.

The assignment heuristics of the BUS1 signal group are designated in column 725 as “@1DN” for the entire signal group. The designation of @1DN for assignment heuristics is what may be termed a bank limitation with an order designation. The “@” symbol is an indication that the logical pins associated with this assignment heuristic are to be assigned only to logical pins in a specific signal pin bank (or banks) of the FPGA. In this example, the pins are only to be assigned to bank 1 of an FPGA associated with the package pinout 200 shown in FIG. 2.

The assignment heuristics for the BUS1 signal group 740 further includes an order designator of “DN” (down). The DN order designator indicates, for this assignment heuristic, that the pins of bank 1 of the pinout 200 should be assigned from top to bottom in the order they are listed in the pin assignment database. For instance, assuming the pins of bank 1 are listed in row-wise fashion in the pin assignment database (e.g., A2, A3, B1, B2 . . . ), the logical pins of the signal group BUS1 would be assigned to available package pins in bank 1 of the pinout 200 starting with pin A2 and proceeding through the list of package pins in order.

Assuming that all of the pins in bank 1 are available, assigning package pins to the logical pins of the BUS1 signal group in the above described situation would result in the following pin assignments. The logical pin DEV_CLK1 would be assigned to the package pin A2 of the pinout 200 as input only pins using IO33_1 as an input structure. The four logical pins of the bus DATA1 would be assigned to package pins A3, B1, B2 and B3 in sequence as input/output pins using IO33_1 as an IO structure.

Alternatively, an order designator of “UP” (up) could have been used in the assignment heuristic for the BUS1 signal group 740 instead of the DN order designator. In this situation, logical pins of the BUS1 signal group 740 would be assigned to package pins of the pinout 200 starting with the last pin of bank 1 (e.g., C3) and proceeding up the listing in order (e.g., C3, C2, C1, B3 . . . ).

The description of the BUS2 signal group 745 in the device description file of FIG. 7 is similar to the description of the BUS1 signal group 740. For instance, in like fashion as the BUS1 signal group 740, the BUS2 signal group 745 includes a logical pin “DEV_CLK2”, which is an input only pin and a logical bus “DATA2” with a width of “4” (four logical pins). The logical pins of the bus DATA2 are input/output pins. The DEV_CLK2 logical pin and the logical pins of the DATA2 bus both use the IO25_1 input/output structure.

The assignment heuristics for the BUS2 signal group 745 are designated as “@2NE.” As with the assignment heuristics for the BUS1 signal group 740, the @2NE assignment heuristic is a bank-limited assignment heuristic, which indicates that the logical pins of the BUS2 signal group 745 are only to be assigned to bank 2 of the pinout 200 shown in FIG. 2.

The assignment heuristic for the BUS2 signal group 745 includes a directional designator of “NE” (north-east), as compared to an order designator (e.g., DN). The NE order designator for this assignment heuristic indicates that the pins of bank 2 of the pinout 200 should be assigned from south to north and west to east using standard map coordinates overlaid on the pinout 200. For instance, assuming that all the pins of bank 2 are available, the logical pins of the signal group BUS2 would be assigned as follows. The logical pin DEV_CLK2 would be assigned to the package pin E1 of the pinout 200. The four logical pins of the bus DATA1 would be assigned to package pins D1, F2, E2 and D2 in sequence.

Alternatively for the NE directional designation, the package pins of the pinout 200 could be assigned to the logical pins of the BUS2 signal group 745 in a serpentine directional fashion, first moving north, then moving east one column, then moving south. In this situation, the package pins of bank 2 would be assigned to the logical pins of the BUS2 signal group 745 as follows. The logical pin DEV_CLK2 would be assigned to the package pin E1 of the pinout 200. The four logical pins of the bus DATA1 would be assigned to package pins D1, D2, E2 and F2 in sequence. Depending on the particular embodiment, a different directional designator may be used for such an approach.

Other combinations of map coordinates may be used as directional designators for assignment heuristics. Each of these combinations would include (i) one of north and south and (ii) one of east and west. Therefore, the list of possible directional indicators includes NE, NW, EN, WN, SE, SW, ES and WS, though others could be used. Such directional designators may be applied in the fashions described above, or in any other appropriate way.

The MISC pin group 750 includes logical pins “MISC_1” and “MISC_2”, where each has a width of “1” designated in column 715. MISC_1 is an input only pin, while MISC_2 is an input/output pin using IO25_2 from the table 600 as an IO structure.

MISC_1 has assignment heuristics that are designated as “PU33V.” Such assignment heuristics may be termed as specific-purpose or specific-function assignment heuristics. The PU33V designation, for this example, indicates that the logical pin MISC_1 should be assigned to a package pin of the pinout 200 that is able to operate as a 3.3 V pull-up device (e.g., does not include a pull-down structure). Depending on the particular FPGA device being used to implement the device design described in the table 700, only certain package pins of the pinout 200 may support such an operation. Thus, based on the PU33V assignment heuristic, the logical pin MISC_1 would be assigned to an available pin of the pinout 200 that supports the specific function of operation as a 3.3V pull-up. Of course, other special-purpose or special-function assignment heuristics are possible, such as JTAG interface pins or scan chain functions, for example. For purposes of package pin to logical pin assignments, special-purpose or special-function assignment heuristics may be considered to be direct pin assignment heuristics due to the fact that there may be a limited number of package pins that support the desired function or purpose of the logical pin.

As shown in FIG. 7, the assignment heuristics for the MISC_2 logical pin in column 725 are blank and there is also no group assignment heuristics defined for the MISC signal group 750. In this situation, the MISC_2 logical pin may be said to have an unrestricted assignment designator or assignment heuristics. In the methods described herein, logical pins with unrestricted assignment designators may be assigned to any available package pin that has compatible bank and pin properties. For instance, the MISC_2 logical pin would be assigned to any available package pin that (i) supports the IO25_2 input/output structure, (ii) is in a signal pin bank which has compatible bank properties with an operating voltage of 2.5V and a reference voltage of 0.9 V. If there are not any package pins available in signal pin banks with compatible bank and pin properties, the MISC_2 logical pin may be assigned to a previously unused signal pin bank, with the bank properties described above being applied to the previously unused signal pin bank.

### Method for Assigning Package Pins to Logical Pins

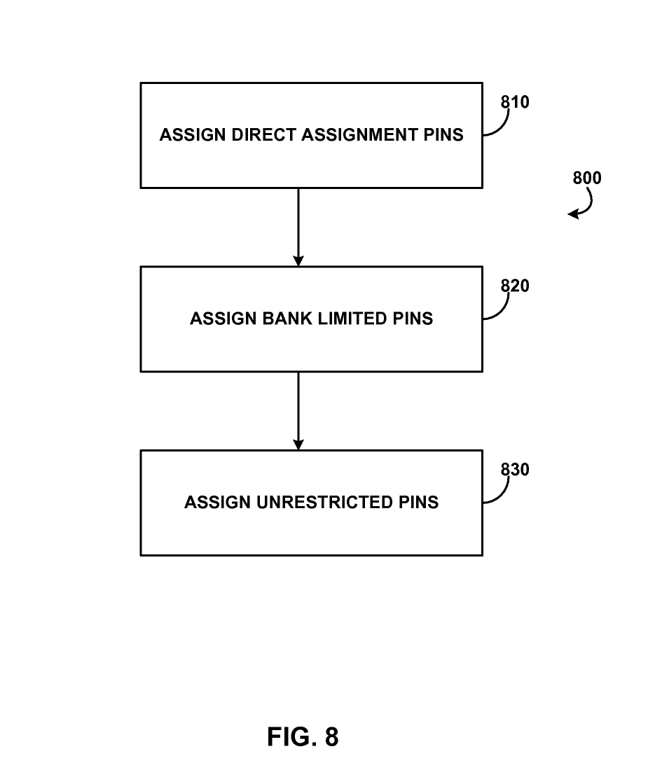

FIG. 8 is a flow chart illustrating a method 800 that may be implemented as block 140 of the method illustrated in FIG. 1. In the method 800, package pins of an FPGA device are assigned in multiple passes to logical pins of a device design that is to be implemented on the FPGA device. The method 800 includes, at block 810, assigning, in a first pass, package pins of the FPGA device to logical pins of the device design with direct pin assignment heuristics, as were described above. At block 820, the method 800 includes assigning, in a second pass, package pins of the FPGA device to logical pins of the device design with bank-limited assignment heuristics, as were also described above. The method 800 further includes, at block 830, assigning, in a third pass, package pins of the FPGA device to logical pins of the device design with unrestricted assignment heuristics.

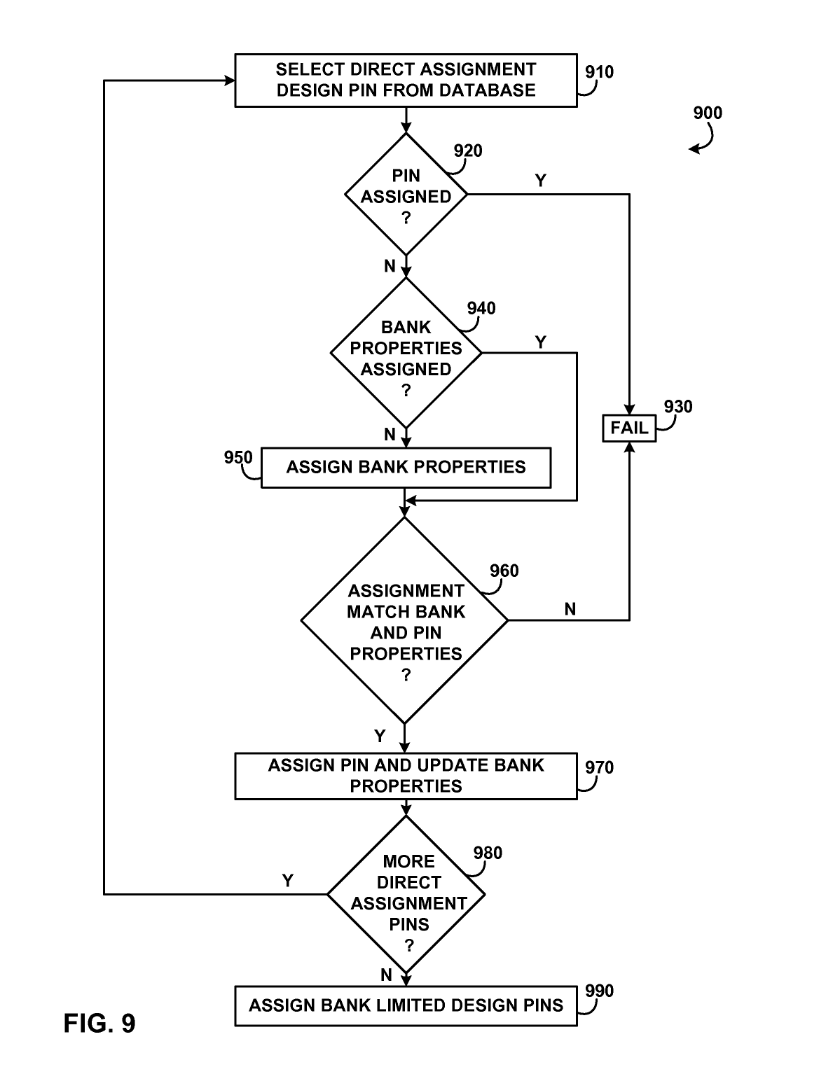

FIG. 9 is a flowchart illustrating a method 900 that may be implemented as block 810 in the method 800 of FIG. 8 to assign package pins of an FPGA device to logical pins of a device design with direct pin assignment heuristics. The method 900 is implemented using a pin assignment database that is generated from a technology description file for an FPGA device (or ASIC device) and a design description file for a device design that is to be implemented on the FPGA device. Such pin assignment databases were described in further detail above.

The method 900 includes, at block 910, selecting a logical pin with direct assignment heuristics (direct assignment logical pin) from the database. As discussed above, logical pins with special-purpose or special-function assignment heuristics may also be considered to be direct assignment logical pins and, therefore, may also be selected at block 910. In the method 900, package pins are assigned to logical pins of the device design in the order that the logical pins are listed in the pin assignment database. Therefore, at block 910 the first direct assignment logical pin listed in the pin assignment database that has not previously been assigned to a package pin is selected.

Applying the method 900 to the device design of FIG. 7, the logical pin DEV_CFG1 (assuming it was not previously assigned to a package pin) would be selected at block 910. As previously discussed, the logical pin DEV_CFG1 has direct pin assignment heuristics to assign package pin F3 to the DEV_CFG1 logical pin.

At block 920 of the method 900, a determination is made whether the package pin (or special-purpose pin) specified in the direct pin assignment heuristics of the selected logical has already been assigned to another logical pin of the device design. If the specified package pin (or special-purpose pin) has already been assigned to another logical pin, the method 900 will move to block 930 and a failure of the method will be indicated to a user (e.g., engineer) implementing the method 900 on, for example, a computer workstation. Once a failure is indicated, assignment of package pins to logical pins typically is halted. This approach allows the user to modify the design description file to address the reason for failure of the pin assignment method. This approach is generally applied for handling indications of failure in the methods described herein.

In the event that the specified package pin (or special-purpose pin) has not been previously assigned, the method 900 then moves to block 940 where a determination is made whether bank properties have been previously assigned to the signal pin bank in which the specified package pin is included. If bank properties have not been assigned, the method 900 moves to block 950, where bank properties are assigned to the signal pin bank that includes the specified package pin. The bank properties are assigned in accordance with the properties of the selected logical pin. For instance, in this example, the selected logical pin is the DEV_CFG1 logical pin.

Referring to FIGS. 6 and 7, the DEV_CFG1 logical pin uses the IO33_2 input/output structure. Therefore, the bank properties for the CFG bank (which includes the specified pin F3, as is shown in FIG. 5) would be assigned to have a 3.3 V operating voltage as the IO33_2 input/output structure is a member of the GROUP 33V, which are IO structures with a 3.3 V operating voltage. As shown in FIG. 6, the IO33_2 input/output structure does not use a reference voltage. Therefore, a reference voltage would not be assigned to the CFG bank as a result of this pin assignment. This approach would allow for subsequent assignment of a reference voltage to the CFG signal pin bank if another GROUP 33V input/output structure that uses a reference voltage (e.g., IO33_1) is used in the CFG signal pin bank.

Once bank properties are assigned (or a determination has been made that bank properties were previously assigned), the method 900 moves to block 960 where a comparison of the properties of the selected logical pin is made with package pin properties of the specified package pin. Additionally, if the bank properties were previously assigned, a comparison of the logical pin properties with the previously assigned bank properties is made. If it is determined, at block 960, that the package pin properties and/or the bank properties of the specified package pin are not compatible with the properties of the logical pin, as specified in the pin assignment database (e.g., from the design description file), the method 900 moves to block 930 and a failure of the method will be indicated to a user and handled in a manner as described above.

In the event that the package pin properties and bank properties of the specified package pin are compatible with the selected logical pin, the method 900 moves to block 970 and the specified package pin is assigned to the selected logical pins. Additionally, the bank properties for the signal pin bank in which the specified package pin is included are updated based on any bank property assignments made at block 950. The package pin assignments and updated bank properties may be included in one or more output files that are used by other design tools (e.g., place and route applications) for example. The output files may take any appropriate form and the exact format of these files depends on the particular embodiment. Further, the selected logical pin and specified package pin may be removed from the pin assignment database or noted in the database as being previously assigned.

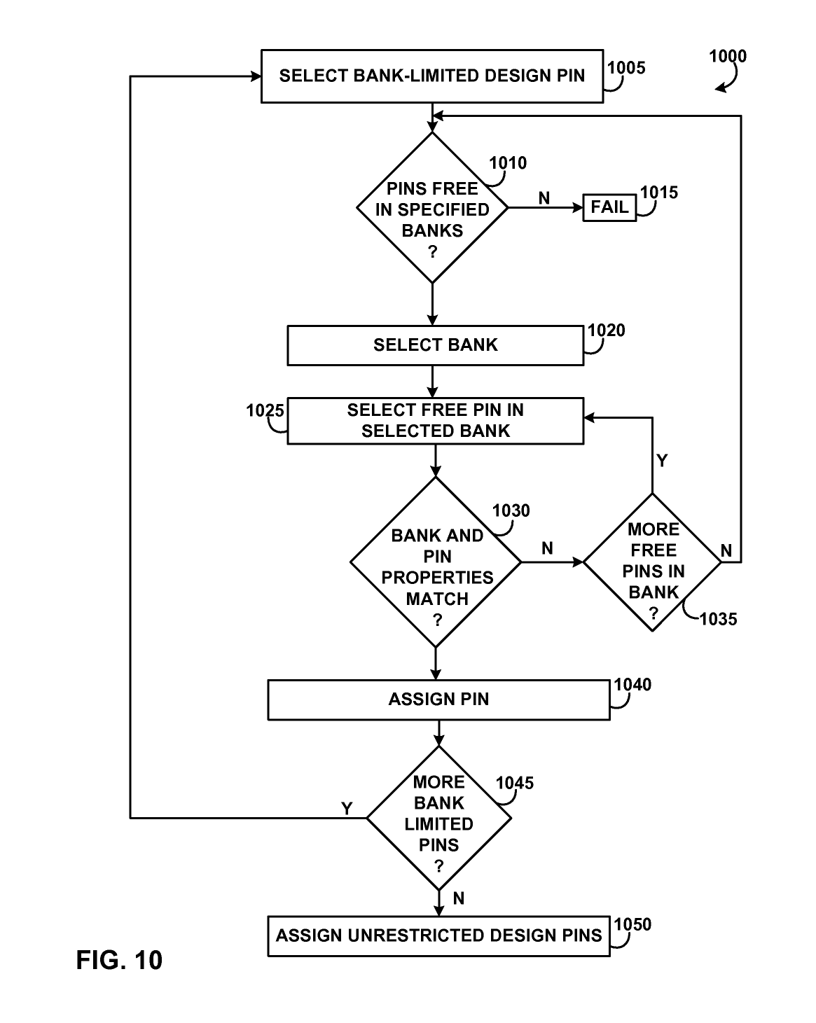

At block 980, a determination is made as to whether the pin assignment database includes any additional logical pins with direct pin assignment heuristics (e.g., including special-purpose or special-function pins) that have not been previously assigned to package pins. If there are additional unassigned logical pins with direct pin assignment heuristics, the method 900 returns to block 910 and the next direct assignment logical pin is selected and assigned using the method 900, as described above. For instance, in this example, the logical pin DEV_CFG2 would be selected for assignment. In the event that there are not any additional direct assignment logical pins, the method 900 moves to block 990 and package pins are assigned to bank-limited logical pins, such as by using the method illustrated in FIG. 10.

FIG. 10 is a flowchart illustrating a method 1000 that may be implemented as block 820 in the method 800 of FIG. 8 to assign package pins to logical pins of the device design with bank-limited assignment heuristics (bank-limited logical pins). As with the method 900 illustrated in FIG. 9, the method 1000 may be implemented using a pin assignment database, such as has been previously described.

In the method 1000, it is assumed that bank properties for the signal pin banks of the FPGA device have been previously assigned. It will be appreciated, however, that the method 1000 may also include assignment of bank properties, such as was described above with respect to the method 900. These operations for assigning bank properties have not been included in the method 1000 for purposes of brevity and clarity.

The method 1000 includes, at block 1005, selecting a logical pin of the device design with bank-limited assignment heuristics. As with the assignment of direct assignment logical pins in the method 900, package pins are assigned to bank-limited logical pins of the device design in the order that the bank-limited logical pins are listed in the pin assignment database for the method 1000. Therefore, at block 1005 the first bank-limited logical pin listed in the pin assignment database that has not previously been assigned to a package pin is selected. Of course, selection of bank-limited logical pins could be made in other fashions.

Applying the method 1000 to the device design of FIG. 7, the logical pin DEV_CLK1 (assuming it was not previously assigned to a package pin) would be selected at block 1005. As previously discussed, the logical pin DEV_CLK1 has bank-limited assignment heuristics to assign the DEV_CLK1 logical pin to a package pin in the signal pin bank 1 of the FPGA device described in the technology description file of FIGS. 5 and 6.

After selecting the DEV_CLK1 logical pin, the method 1000 moves to block 1010, where a determination is made as to whether there are unassigned pins in the banks specified in the bank-limited assignment heuristics. As discussed above, the assignment heuristics for the DEV_CLK1 pin include a bank-limitation for assignment to only bank 1 of the FPGA device. However, the bank-limitation may specify multiple banks. For instance the bank-limited assignment heuristics could specify signal pin bank 1 and 3, for example. The method 1000 is applicable for both single and multiple bank limitations.

If it is determined, at block 1010, that there are not any available package pins in the signal pin banks specified in the bank-limited assignment heuristics for assignment to the selected logical pin, the method 1000 moves to block 1015 and an indication of failure, such as previously described, is provided to a user. As a result of failure of the method 1000, assignment of package pins to logical pins is halted.

If it is determined that there are package pins available in the specified signal pin banks, the method 1000 moves to block 1020 where one of the specified signal pin banks is selected. In the case of multiple signal pin banks being specified, a selection process may be applied. For instance, the signal pin bank with the greatest number of available package pins may be selected. Of course, any number of other criteria could also be applied to select a signal pin bank at block 1020.

After selection of a signal pin bank at block 1020, the method 1000 moves to block 1025 where an unassigned pin of the selected bank is identified for possible assignment to the selected bank-limited logical pin. Identifying a package pin at block 1025 is done in accordance with the assignment heuristics for the selected logical pin. For example, for the DEV_CLK1 logical pin, the assignment heuristics for the BUS1 signal group 735 (which includes the DEV_CLK1 logical pin) are designated as @1DN, which was discussed above. Therefore, the selection of the package pin at block 1025 should be made in accordance with the DN order designator. As an example, referring to the pinout 200 of FIG. 2, if only pin A2 of the signal pin bank 1 was previously assigned, the pin A3 would be selected at block 1025, assuming the pins of the pinout 200 are listed in row-wise fashion in the pin assignment database.

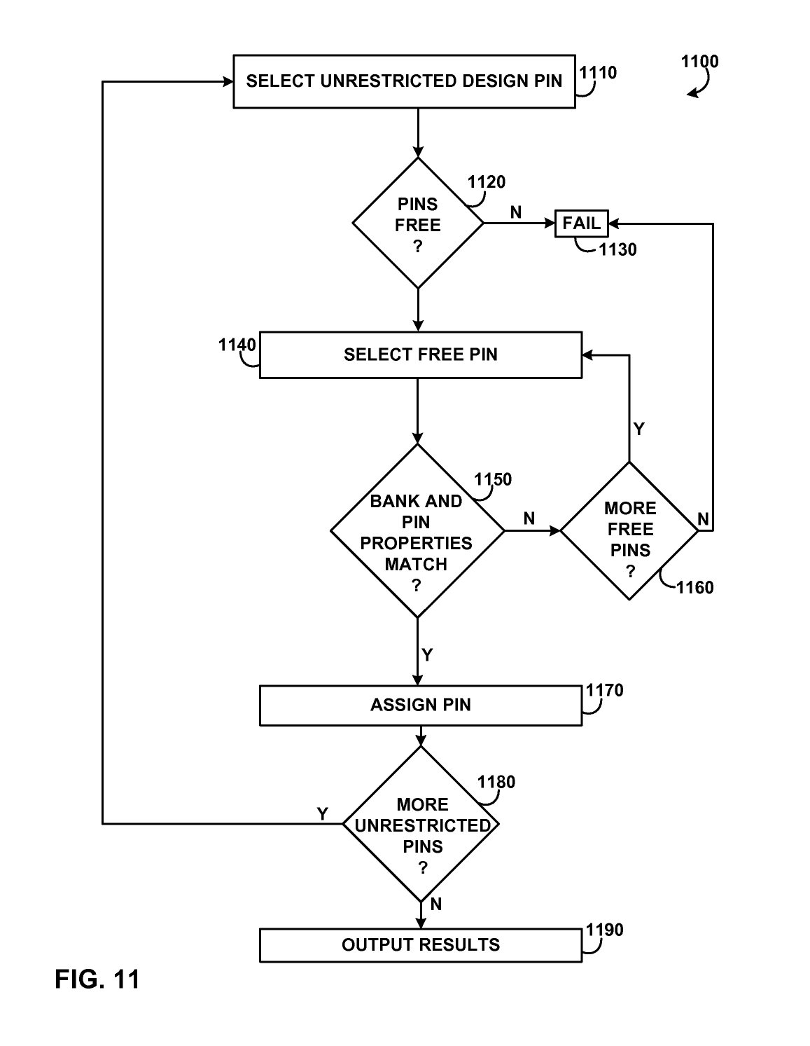

At block 1030, the bank properties and pin properties of the package pin identified at block 1025 are compared to the properties of the selected logical pin. If the bank properties and pin properties are compatible (match), the method 1000 moves to block 1040 where the identified package pin is assigned to the selected logical pin in a similar fashion as was described above with respect to the method 900. The method then moves to block 1045 where a determination is made as to whether there are additional bank-limited logical pins to be assigned to package pins in the pin assignment database. If there are additional bank-limited logical pins to assign, the method 1000 returns to block 1005 and assigns the next bank-limited logical pin in accordance with the method 1000. If there are not additional bank-limited logical pins to assign, the method 1000 moves to block 1050 and package pins are assigned to unrestricted logical pins, such as by using the method illustrated in FIG. 11.

In the event that the bank properties and/or pin properties of the identified package pin do not match the properties of the selected logical pin, the method 1000 moves to block 1035 where a determination is made as to whether there are additional unassigned package pins available in the selected signal pin bank. If there are, the method 1000 returns to block 1025 and continues. If there are no unassigned package pins available in the selected bank, the method 1000 returns to block 1010 and continues. If a only single signal pin bank was included in the bank-limitation for the selected logical pin, a determination would then be made at block 1010 that there are no available pins for assignment and the method would proceed to block 1015 and fail. If additional signal pin banks were included in the bank limitation for the selected logical pin, the method 1000 would continue at block 1010, as has discussed above.

FIG. 11 is a flowchart illustrating a method 1100 that may be implemented as block 830 in the method 800 of FIG. 8 to assign package pins to logical pins of the device design with unrestricted assignment heuristics (unrestricted logical pins). As with the methods 900 and 1000 illustrated in FIGS. 9 and 10, the method 1100 may be implemented using a pin assignment database, such as has been previously described.

In the method 1100, as with the method 1000, it is assumed that bank properties for the signal pin banks of the FPGA device have been previously assigned. It will be appreciated, however, that the method 1100 may also include assignment of bank properties, such as was described above with respect to the method 900. These operations for assigning bank properties have not been included in the method 1100 for purposes of brevity and clarity.

The method 1100 includes, at block 1110, selecting a logical pin of the device design with unrestricted assignment heuristics (an unrestricted logical pin). As with the assignment of direct assignment and bank-limited logical pins in the methods 900 and 1000, in the method 1100, package pins are assigned to unrestricted logical pins of the device design in the order that the bank-limited logical pins are listed in the pin assignment database. Therefore, at block 1110 the first unrestricted logical pin listed in the pin assignment database that has not previously been assigned to a package pin is selected. Of course, selection of unrestricted logical pins could be made in other fashions.

Applying the method 1100 to the device design of FIG. 7, the logical pin MISC_2 (assuming it was not previously assigned to a package pin) would be selected at block 1110. For the device design of FIG. 7, the MISC_2 logical pin is the only unrestricted logical pin. As previously discussed, the logical pin MISC_2 has unrestricted assignment heuristics, indicating that the MISC_2 logical pin may be assigned to any package pin with compatible bank and pin properties.

After selecting the MISC_2 logical pin, the method 1100 moves to block 1120, where a determination is made as to whether there are any unassigned package pins on the FPGA. If it is determined, at block 1120, that there are not any available package pins, the method 1100 moves to block 1130 and an indication of failure, such as previously described, is provided to a user. As a result of failure of the method 1100, assignment of package pins to logical pins is halted to afford the user the opportunity to correct the cause of the failure.

If it is determined that there are package pins available, the method 1100 moves to block 1140 where one of the available package pins is selected. In the case of multiple package pins being available, a selection process may be applied. For instance, the first available package pin listed in the pin assignment database may be selected. Of course, any number of other criteria could also be applied to select an available package pin at block 1140.

At block 1150, the bank properties and pin properties of the package pin identified (selected) at block 1140 are compared to the properties of the selected logical pin (e.g., MISC_2). If the bank properties and pin properties are compatible (match), the method 1100 moves to block 1170, where the identified package pin is assigned to the selected logical pin in a similar fashion as was described above with respect to the method 900. The method 1100 then moves to block 1180 where a determination is made as to whether there are additional unrestricted logical pins to be assigned in the pin assignment database. If there are additional unrestricted logical pins to assign, the method 1100 returns to block 1110 and assigns the next unrestricted logical pin in accordance with the method 1100. If there are no additional unrestricted logical pins to be assigned to package pins, the method 1100 moves to block 1190 and output files with pin assignment information and bank properties for the FPGA, such as those output files previously described with respect to FIGS. 3 and 4, are created.

In the event that the bank properties and/or pin properties of the identified package pin do not match the properties of the selected logical pin, the method 1100 moves to block 1160 where a determination is made as to whether there are additional unassigned package pins available. If there are, the method 1100 returns to block 1140 and continues. If there are not any unassigned package pins available, the method 1100 moves to block 1130 and an indication of failure is provided to the user.

### CONCLUSION

While a number of aspects and embodiments have been discussed above, it will be appreciated that various modifications, permutations, additions and/or sub-combinations of these aspects and embodiments are possible. It is therefore intended that the following appended claims and claims hereafter introduced are interpreted to include all such modifications, permutations, additions and/or sub-combinations as are within their true spirit and scope.

What is claimed is:

1. A method for assigning package pins of an electronic device to logical pins of a device design to be implemented on the electronic device, the method comprising:
receiving a technology description file for the electronic device, the technology description file including a catalog of information for the electronic device;
receiving a design description file for the device design, the design description file including a catalog of information for the device design;
creating a database from the technology description file and the design description file, the database for use in assigning the package pins of the electronic device to the logical pins of the device design; and
programmatically assigning the package pins of the electronic device to the logical pins of the device design using the database.

2. The method of claim 1, wherein the electronic device is one of a field programmable gate array device and an application specific integrated circuit device.

3. The method of claim 1, further comprising:
creating an output file including package pin assignments of the logical pins of the device design to the package pins of the electronic device.

4. The method of claim 3, wherein the output file comprises a file for use by a place and route application.

5. The method of claim 3, wherein the output file comprises a spreadsheet file graphically illustrating package pin assignments of the logical pins of the device design to the package pins of the electronic device.

6. The method of claim 1, wherein the catalog of information for the electronic device includes:
a description of each package pin of the electronic device including:
a bank assignment;
a pin type;
a physical location; and
an electronic device pin name; and
a description of each type of input/output structure available on the electronic device including, for each type of input/output structure, one or more of:
bank input and output voltages;
input reference voltages; and
differential reference voltages.

7. The method of claim 1, wherein the catalog of information for the device design includes:
for each logical pin of the device design:
a device design pin name;
an input/output type;
an input/output direction; and
assignment heuristics.

8. The method of claim 7, wherein the assignment heuristics for each device design pin includes one of:
a specific package pin location;
a specific pin function;
a list of one or more banks of which to assign the device design pin; and
an unrestricted assignment designator.

9. The method of claim 8, wherein the catalog of information for the device design further includes one or more groupings of device design pins and the assignment heuristics further include at least one of:
a directional indicator for assignment of device design pins to package pins of the electronic device for at least one grouping of the one or more groupings of device pins; and
an order indicator for assignment of device design pins to package pins of the electronic device for at least one grouping of the one or more groupings of device design pins.

10. A method for assigning package pins of an electronic device to logical pins of a device design to be implemented on the electronic device, the method comprising:
receiving a technology description file for the electronic device, the technology description file including a catalog of information for the electronic device;
receiving a design description file for the device design, the design description file including a catalog of information for the device design;
creating a database from the technology description file and the design description file, the database for use in assigning the package pins of the electronic device to the logical pins of the device design; and
programmatically assigning the package pins of the electronic device to the logical pins of the device design using the database, wherein the package pins of the electronic device are assigned to the logical pins of the device design in multiple passes based, at least in part, on assignment heuristics of the logical pins of the device design, the assignment heuristics being included in the design description file.

11. The method of claim 10, wherein programmatically assigning the package pins of the electronic device to the logical pins of the device design comprises:
in a first pass, assigning package pins of the electronic device to logical pins of the device design with assignment heuristics that include a direct package pin assignment;
in a second pass, assigning package pins of the electronic device to logical pins of the device design with assignment heuristics that include a bank limitation; and
in a third pass, assigning package pins of the electronic device to logical pins of the device design with assignment heuristics that include an unrestricted assignment designator.

12. The method of claim 11, wherein assigning package pins of the electronic device to logical pins of the device design in the first pass comprises:
(a) selecting a logical pin of the device design, the selected logical pin having (i) logical pin properties and (ii) assignment heuristics that include a respective direct package pin assignment to a specific package pin;
(b) determining whether bank properties have been assigned to a respective signal pin bank corresponding with the specific package pin;
(c) in the event that bank properties have not been assigned to the respective signal pin bank, assigning bank properties to the respective bank based, at least in part, on the logical pin properties;
(d) in the event that bank properties have been assigned to the respective signal pin bank, comparing the logical pin properties with the bank properties of the respective bank;
(e) in the event that the logical pin properties are not compatible with the bank properties of the respective signal pin bank, discontinuing assigning package pins of the electronic device to logical pins of the device design;
(f) in the event that the logical pin properties are compatible with the bank properties of the respective signal pin bank, comparing the logical pin properties with package pin properties of the specific package pin;
(g) in the event that the logical pin properties are not compatible with the package pin properties of the specific package pin, discontinuing assigning package pins of the electronic device to logical pins of the device design; and
(h) in the event that the logical pin properties are compatible with the package pin properties of the specific package pin, updating an output file with an assignment of the specific package pin to the selected logical pin.

13. The method of 12, further comprising, after step (a) and prior to step (h):
determining whether the specific package pin has been previously assigned; and
in the event that the specific package pins has been previously assigned, discontinuing assigning package pins of the electronic device to logical pins of the device design.

14. The method of claim 12, wherein assigning package pins of the electronic device to logical pins of the device design in the first pass further comprises:
determining whether additional logical pins having assignment heuristics including direct package pin assignments are included in the database; and
in the event that additional logical pins having assignment heuristics including direct package pin assignments are included in the database, assigning package pins of the electronic device to the additional logical pins in accordance with steps (a) through (h).

15. The method of claim 11, wherein assigning package pins of the electronic device to logical pins of the device design in the second pass comprises assigning package pins of the electronic device to bank-limited logical pins of the device design, the bank-limited logical pins each having (i) logical pin properties and (ii) assignment heuristics that include a respective bank limitation, each respective bank limitation including one or more signal pin banks of the electronic device to which the corresponding bank-limited logical pin can be assigned.

16. The method of claim 15, wherein assigning package pins of the electronic device to logical pins of the device design in the second pass further comprises assigning package pins of the electronic device to the bank-limited logical pins of the device design based, at least in part, on:
the logical pin properties of the bank-limited logical pins;
bank properties of the signal pin banks of the respective bank limitations; and
availability of package pins in the signal pin banks of the respective bank limitations.

17. The method of claim 11, wherein assigning package pins of the electronic device to logical pins of the device design in the third pass comprises assigning package pins of the electronic device to unrestricted logical pins of the device design, the unrestricted logical pins each having (i) logical pin properties and (ii) assignment heuristics that include a respective unrestricted assignment designator, wherein the unrestricted logical pins are assigned to any available package pin with bank properties and pin properties that are compatible with the respective logical pin properties.

18. The method of claim 17, wherein assigning package pins of the electronic device to logical pins of the device design in the third pass further comprises assigning package pins of the electronic device to the unrestricted logical pins of the device design based, at least in part, on:
the logical pin properties of the unrestricted logical pins;
availability of unassigned package pins of the electronic device; and
bank properties and pin properties of the unassigned package pins.

19. A workstation for assigning package pins of an electronic device to logical pins of a device design to be implemented on the electronic device, the workstation comprising machine readable instructions that, when executed by the workstation, provide for:
receiving a technology description file for the electronic device, the technology description file including a catalog of information for the electronic device;
receiving a design description file for the device design, the design description file including a catalog of information for the device design;
creating a database from the technology description file and the design description file, the database for use in assigning the package pins of the electronic device to the logical pins of the device design; and
assigning the package pins of the electronic device to the logical pins of the device design using the database.

20. The workstation of claim 19, wherein the instructions, when executed, further provide for:
creating an output file including package pin assignments of the logical pins of the device design to the package pins of the electronic device.

21. The workstation of claim 19, wherein the package pins of the electronic device are assigned to the logical pins of the device design in multiple passes based, at least in part, on assignment heuristics of the logical pins of the device design, the assignment heuristics being included in the design description file, wherein the instructions, when executed, further provide for:
in a first pass, assigning package pins of the electronic device to logical pins of the device design with assignment heuristics that include a direct package pin assignment;
in a second pass, assigning package pins of the electronic device to logical pins of the device design with assignment heuristics that include a bank limitation; and
in a third pass, assigning package pins of the electronic device to logical pins of the device design with assignment heuristics that include an unrestricted assignment designator.
